(19) United States
(12) Patent Application Publication
(10) Pub. No.: US 2018/0041911 A1
(43) Pub. Date: Feb. 8, 2018

(54) CONTROL APPARATUS, WIRELESS COMMUNICATION SYSTEM, AND CONTROL METHOD

(71) Applicant: FUJITSU LIMITED, Kawasaki-shi (JP)

(72) Inventor: Yun WEN, Kawasaki (JP)

(73) Assignee: FUJITSU LIMITED, Kawasaki-shi (JP)

(21) Appl. No.: 15/649,240

(22) Filed: Jul. 13, 2017

(30) Foreign Application Priority Data
Aug. 2, 2016 (JP) 2016-152106

(51) Int. Cl. H04W 24/08; H04W 72/04; H04W 74/08; H04L 12/26

(52) U.S. Cl. CPC H04W 24/08; H04L 43/16; H04W 72/0473; H04W 74/0816; H04W 88/08

(57) ABSTRACT

A control apparatus includes a memory, and a processor coupled to the memory and configured to receive a first received power value for a first signal received from a first base station and a second received power value for a second signal received from a second base station adjacent to the first base station in a first terminal under control of the first base station, from the first terminal, through the first or second base station, calculate a threshold for each pair of the one or more first terminals and the one or more second base stations, based on the received first and second received power values, and transmit the calculated threshold to the first base station.

### CROSS-REFERENCE TO RELATED APPLICATION

This application is based upon and claims the benefit of priority of the prior Japanese Patent Application No. 2016-152106, filed on Aug. 2, 2016, the entire contents of which are incorporated herein by reference

### FIELD

The embodiments discussed herein are related to a control apparatus, a wireless communication system, and a control method.

### BACKGROUND

Currently, a terminal (or a user) can use not only a wireless access method such as long term evolution (LTE), but also a wireless access method such as a wireless local area network (wireless LAN). The wireless LAN is a wireless access method whose specification was examined by, for example, Institute of Electrical and Electronic Engineers (IEEE). Examples of the wireless LAN include IEEE 802.11ac (or Very High Throughput (VHT)), IEEE 802.11n, and the like.

In a wireless LAN system, a Carrier Sense Multiple Access/Collision Detection (CSMA/CA) communication method may be used. The CSMA/CA communication method is, for example, a communication method in which a carrier sense method and a collision avoidance algorithm are combined. For example, in the CSMA/CA communication method, when the received power value of a certain channel (or frequency) is equal to or greater than a carrier sense threshold, an access point (AP) waits for transmission. Otherwise, the AP starts transmission.

For example, in an environment where APs are disposed at high density, such as stations and underground malls, the AP detects many signals transmitted from other APs compared to other environments. In this case, when the received power value of a signal detected by the AP is equal to or greater than the carrier sense threshold, the AP waits for transmission. Therefore, in the environment in which the APs are disposed in this manner, there is a high possibility that the AP receives a signal which is equal to or greater than the carrier sense threshold, compared to other environments, such that the opportunity of signal transmission in the AP decreases, and the throughput may decrease. Such a phenomenon may sometimes be referred to as, for example, an exposed terminal problem.

Examples of a technique relating to a wireless LAN are as follows. That is, there is a wireless communication system in which simultaneous communication is performed by updating carrier sense level values of two base stations, only in a case where any base station in a pair of the two base stations is capable of setting a carrier sense level value to a value larger than the RSSI value received from the opposite station. In this case, in the wireless communication system, when only one of two base stations can raise the carrier sense level value, the level value is kept unchanged without being updated.

Japanese Laid-open Patent Publication No. 2015-167286 is an example of the related art.

According to this technique, it is said that throughput by carrier sense control can be improved in environments of dense wireless LANs.

### SUMMARY

According to an aspect of the invention, a control apparatus includes a memory, and a processor coupled to the memory and configured to receive a first received power value for a first signal received from a first base station and a second received power value for a second signal received from a second base station adjacent to the first base station in a first terminal under control of the first base station, from the first terminal, through the first or second base station, calculate a threshold for each pair of the one or more first terminals and the one or more second base stations, based on the received first and second received power values, and transmit the calculated threshold to the first base station.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a wireless communication system;

FIG. 2 is a diagram illustrating a configuration example of a central control station device;

FIG. 3 is a diagram illustrating a configuration example of an AP;

FIG. 4 is a diagram illustrating a configuration example of a terminal;

FIG. 5A is a diagram illustrating an example of a relationship between a received power value and a carrier sense threshold, and FIG. 5B is a diagram illustrating an example of a relationship between received power values of adjacent APs;

FIG. 6 is a diagram illustrating a configuration example of the wireless communication system;

FIG. 7 is a flowchart illustrating an operation example;

FIG. 8A and FIG. 8B are diagrams illustrating examples of carrier sense thresholds;

FIG. 9 is a flowchart illustrating an operation example;

FIG. 10 is a flowchart illustrating an operation example;

FIG. 11A and FIG. 11B are diagrams illustrating examples of the carrier sense thresholds;

FIG. 12 is a flowchart illustrating an operation example;

FIG. 13 is a diagram illustrating an example of a relationship between S and I;

FIG. 14 is a diagram illustrating a configuration example of a wireless communication system;

FIG. 15A is a diagram illustrating a hardware configuration example of a central control station device, and FIG. 15B is a diagram illustrating a hardware configuration example of an AP; and

FIG. 16 is a diagram illustrating a hardware configuration example of the terminal.

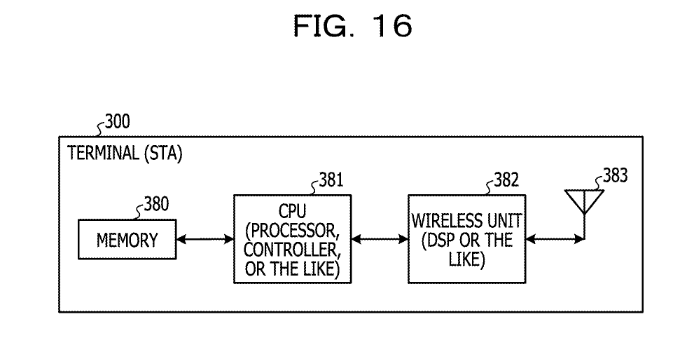

### DESCRIPTION OF EMBODIMENTS

In the technique of updating carrier sense level values of two base stations, for example, when only one of the two base stations can raise the carrier sense level value, the level value is kept unchanged without being updated. Therefore, according to the technique, even if there is one terminal that does not satisfy a desired communication quality among a plurality of terminals under control of one base station, even if the other terminals satisfy the desired communication quality, the terminals under control of the one base station do not perform simultaneous communication. In this case, opportunities for simultaneous communication decrease, and this leads to a decrease in throughput of the whole system.

Accordingly, a disclosure is to provide a control apparatus, a wireless communication system, and a control method that improve throughput of the whole system.

Hereinafter, embodiments will be described. The following embodiments are not intended to limit the disclosed technique. Respective embodiments can be combined appropriately as long as the processing contents do not contradict each other.

In addition, the terms and technical contents described in the specification as the standard related to communication such as IEEE may be appropriately used for the terms and technical contents described herein.

### First Embodiment

Configuration Example of Wireless Network System

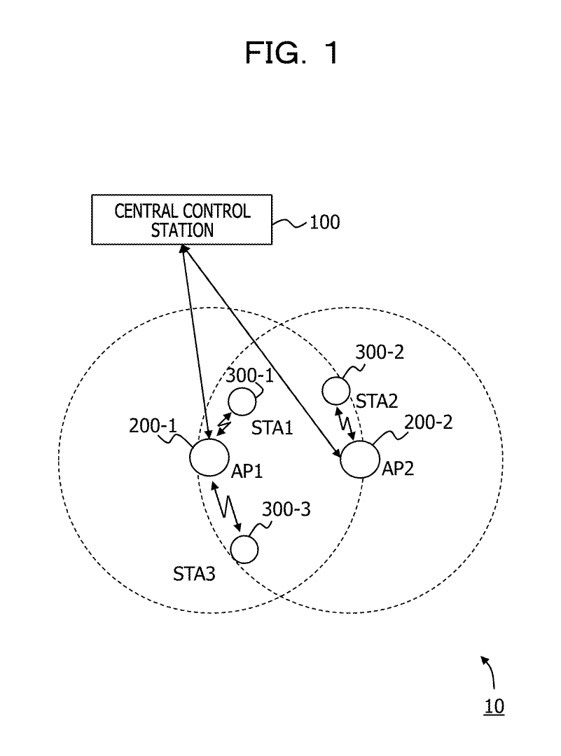

FIG. 1 is a diagram illustrating a configuration example of a wireless communication system 10 in a first embodiment. The wireless communication system 10 includes a central control station device (hereinafter, may be referred to as a “central control station”) 100, access points (hereinafter, may be referred to as an “AP”) 200-1 and 200-2, terminal devices (hereinafter, may be referred to as “terminals”) 300-1 to 300-3.

In the first embodiment, each of the APs 200-1 and 200-2 performs wireless communication with the terminal 300-1 to 300-3 through a wireless LAN method. As the wireless LAN method, for example, IEEE 802. 11 series, such as IEEE 802.11ac and IEEE 802.11n may be used. In this case, the APs 200-1 and 200-2 and the terminals 300-1 to 300-3 respectively perform wireless communication using a carrier sensing method. As the carrier sensing method, for example, a CSMA/CD method, a CSMA/Collision Avoidance (CA) method, or the like may be used. In the first embodiment, the CSMA/CD method will be described.

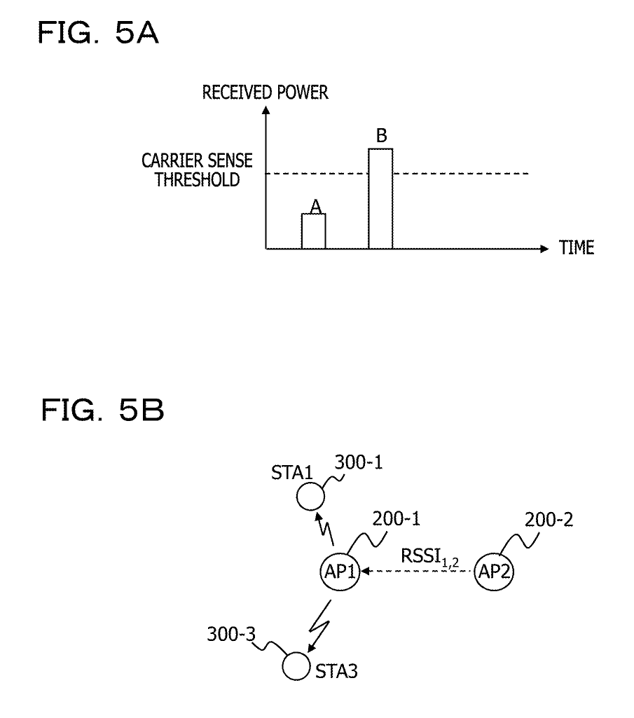

FIG. 5A illustrates an example of a relationship between a carrier sense threshold and a received power value. In the carrier sense method, for example, each of the APs 200-1 and 200-2 waits for transmission when the received power value for the use frequency is equal to or greater than the carrier sense threshold (“B” in FIG. 5A). On the other hand, each of the APs 200-1 and 200-2 starts transmission when the received power value is less than the carrier sense threshold (“A” in FIG. 5A). In the first embodiment, each of the APs 200-1 and 200-2 performs wireless communication with the terminals 300-1 to 300-3 in a downlink (DL) direction using such a carrier sense method. For example, the DL direction is a communication direction from the AP 200 to the terminal 300, and a UL direction is a communication direction from the terminal 300 to the AP 200.

Returning to FIG. 1, the central control station 100 collects various types of information acquired by the APs 200-1 and 200-2 during wireless communication with the subordinate terminals 300-1 to 300-3, from each of the APs 200-1 and 200-2. Examples of various types of information include the received power value of a signal received from the AP 200-1 and the received power value of a signal received from the AP 200-2, in the terminal 300-1. Such received power values are measured in the terminal 300-1, and transmitted to the central control station 100 through the AP 200-1 or the AP 200-2. The central control station 100 calculates a carrier sense threshold based on these pieces of information collected from the respective APs 200-1 and 200-2, and transmits the calculated carrier sense threshold to the respective APs 200-1 and 200-2. A method by which the central control station 100 calculates the carrier sense threshold will be described in the operation example.

The APs 200-1 and 200-2 are, for example, base stations (or wireless communication apparatuses) capable of wireless communication with the terminals 300-1 to 300-3 using a wireless LAN. Each of the APs 200-1 and 200-2 provides various services such as a call service and a Web browsing service, in a service available range (or a communication coverage) of each station.

In the first embodiment, the two APs 200-1 and 200-2 are adjacent to each other. Being adjacent (or adjacent APs) means, for example, a relationship in which the two communication coverages of the two APs 200-1 and 200-2 overlap and the two APs 200-1 and 200-2 are disposed in the overlapping coverage. Since the two APs 200-1 and 200-2 are adjacent to each other, the AP 200-1 can receive the signal transmitted from the AP 200-2 and the AP 200-2 can also receive the signal transmitted from the AP 200-1.

The terminals 300-1 to 300-3 are, for example, wireless communication device capable of wireless communication with the respective APs 200-1 and 200-2. Examples of the terminal 300-1 to 300-3 are feature phones, smartphones, tablet terminals, personal computers, game devices, or the like.

The example of FIG. 1 represents an example in which the terminals 300-1 and 300-3 perform wireless communication with the AP 200-1 and the terminal 300-2 performs wireless communication with the AP 200-2. In this case, the terminals 300-1 to 300-3 performing wireless communication with each of the APs 200-1 and 200-3 may be referred to as, for example, “a terminal under control” or “a subordinate terminal”. In the example of FIG. 1, the subordinate terminals of the AP 200-1 are the terminals 300-1 and 300-3, and the subordinate terminals of the AP 200-2 are the terminal 300-2.

The example of FIG. 1 represents an example in which there are two APs 200-1 and 200-2, but three or more APs may be used. Further, the number of terminals 300-1 to 300-3 under control of the respective APs 200-1 and 200-2 may be one or plural.

In the following description, the APs 200-1 and 200-2 may be referred to as the AP 200 and the terminals 300-1 to 300-3 may be referred to as the terminal 300 in some cases, unless otherwise noted.

Next, the configuration examples of the central control station 100, the AP 200, and the terminal 300 will be described.

Configuration Example of Central Control Station

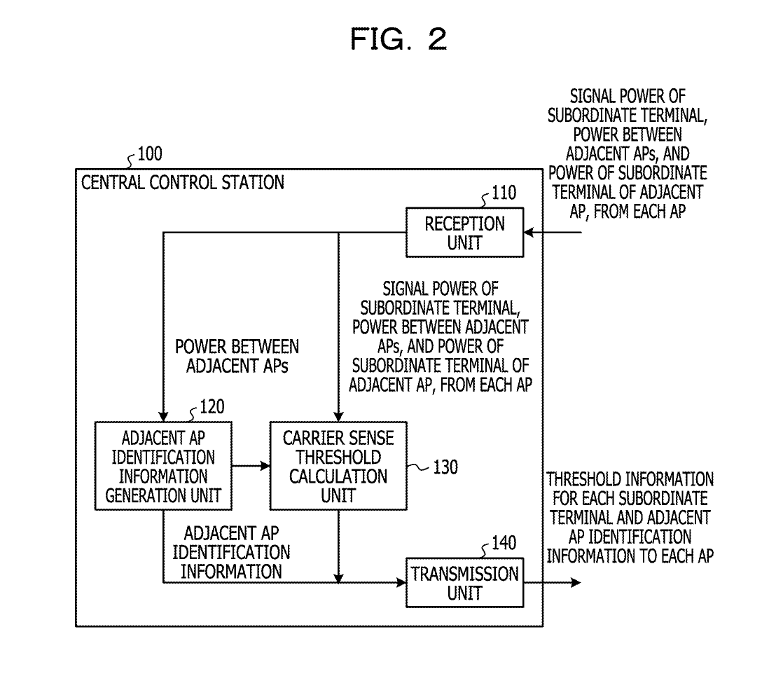

FIG. 2 is a diagram illustrating a configuration example of the central control station 100. The central control station 100 includes a reception unit 110, an adjacent AP identification information generation unit 120, a carrier sense threshold calculation unit 130, and a transmission unit 140.

The reception unit 110 receives the information transmitted from each AP 200. The transmitted information includes the received power value when the subordinate terminal 300 of the AP 200 receives the signal transmitted from the AP 200, the received power value when the subordinate terminal 300 of the AP 200-1 receives the signal transmitted from the adjacent AP 200-2, power between adjacent APs, or the like. The received power value between adjacent APs includes the received power value when the AP 200-1 receives a signal transmitted from the adjacent AP 200-2, and the received power value when the AP 200-2 receives a signal transmitted from the adjacent AP 200-1. The reception unit 110 outputs the received power values to the carrier sense threshold calculation unit 130 and outputs the power between adjacent APs to the adjacent AP identification information generation unit 120.

The adjacent AP identification information generation unit 120 extracts the identification information of the adjacent AP included in the adjacent AP power and outputs the extracted identification information of the adjacent AP to the carrier sense threshold calculation unit 130 and the transmission unit 140.

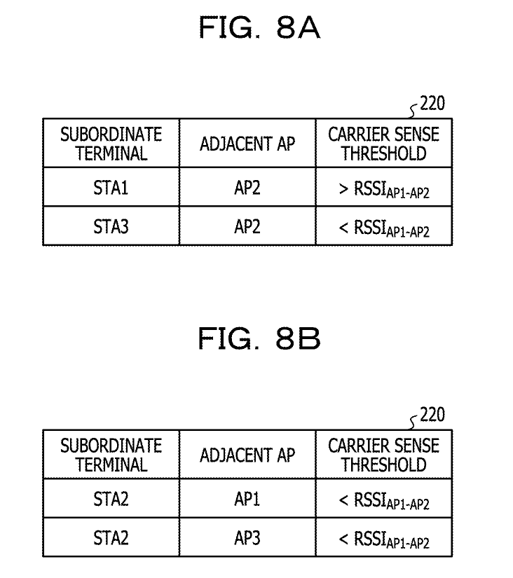

The carrier sense threshold calculation unit 130 calculate a carrier sense threshold for each pair of a subordinate terminal 300 of the AP 200-1 and an adjacent AP 200-2, as a carrier sense threshold for the AP 200-1, based on the received power value collected from each AP 200 or the like. FIG. 8A illustrates an example of a carrier sense threshold for the AP 200-1, and FIG. 8B illustrates an example of a carrier sense threshold for the AP 200-2. As illustrated in FIG. 8A and FIG. 8B, the carrier sense thresholds have, for example, different thresholds for each subordinate terminal 300 and for each adjacent AP 200. Details of the calculation will be described in the operation example. Returning to FIG. 2, the carrier sense threshold calculation unit 130 outputs the calculated carrier sense threshold to the transmission unit 140.

The transmission unit 140 transmits the carrier sense threshold and the adjacent AP identification information to each AP 200.

Configuration Example of AP

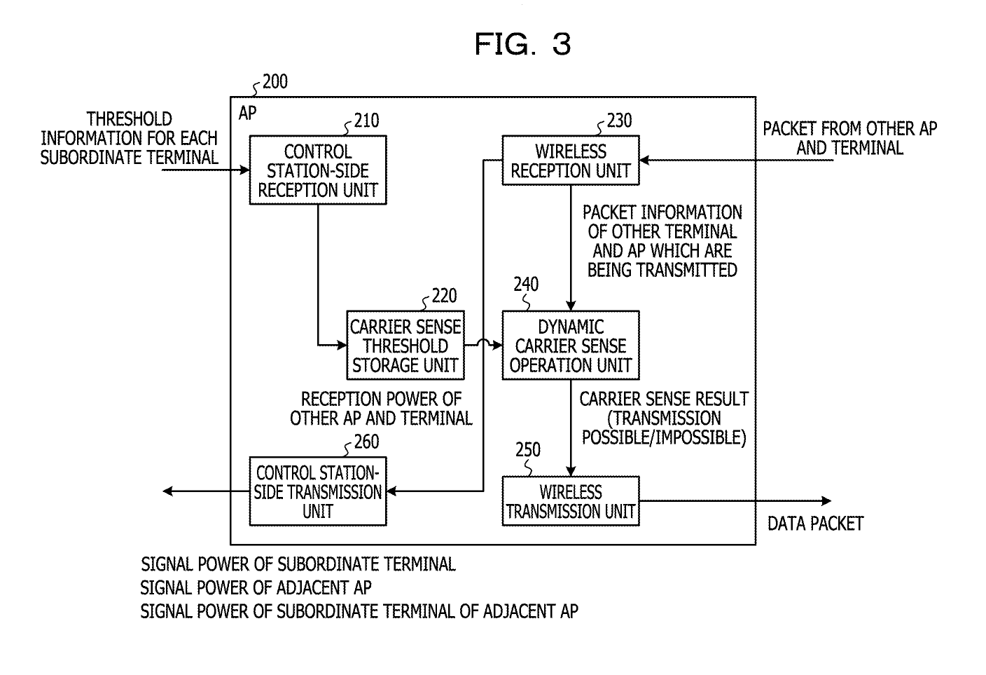

FIG. 3 is a diagram illustrating a configuration example of the AP 200. The AP 200 includes a control station-side reception unit 210, a carrier sense threshold storage unit 220, a wireless reception unit 230, a dynamic carrier sense operation unit 240, a wireless transmission unit 250, and a control station-side transmission unit 260.

The control station-side reception unit 210 receives the carrier sense threshold and the like transmitted from the central control station 100. The control station-side reception unit 210 stores the received carrier sense threshold and the like in the carrier sense threshold storage unit 220.

The carrier sense threshold storage unit 220 is, for example, a memory, or the like, and stores a carrier sense threshold for each pair of the subordinate terminal 300 and the adjacent AP 200. FIG. 8A and FIG. 8B above represent examples of the carrier sense threshold stored in the carrier sense threshold storage unit 220.

Returning to FIG. 3, the wireless reception unit 230 receives wireless signals transmitted from the subordinate terminal 300 and the adjacent AP 200, and extracts packet data from the wireless signal. The wireless reception unit 230 extracts, from the packet data, the received power value measured in the terminal 300, the power between adjacent APs measured by the adjacent AP 200, packet information, or the like. The wireless reception unit 230 outputs the received power value and the like to the control station-side transmission unit 260, and outputs packet information and the like to the dynamic carrier sense operation unit 240.

Further, the wireless reception unit 230 may measure the received power value of the signal transmitted from the adjacent AP 200, and transmit it to the control station-side transmission unit 260 as the power between the adjacent APs or transmit it to the adjacent power AP 200. In this case, the wireless reception unit 230 may generate adjacent AP identification information indicating APs between which the power is measured, for the measured power between adjacent APs, and transmit the power between adjacent APs to the central control station 100 and the adjacent AP. When receiving the power between adjacent APs measured in the adjacent AP 200-2, the wireless reception unit 230 may transmit the received power between adjacent APs together with the adjacent AP identification information to the central control station 100.

The dynamic carrier sense operation unit 240 reads the carrier sense threshold stored in the carrier sense threshold storage unit 220, and acquires the received power value of the packet data received by the wireless reception unit 230. Then, the dynamic carrier sense operation unit 240 determines transmission availability as to whether the AP 200 is to perform transmission, based on the carrier sense threshold and the received power value. The dynamic carrier sense operation unit 240 outputs the transmission availability (or a carrier sense result) to the wireless transmission unit 250. The operation of the dynamic carrier sense operation unit 240 will be described in an operation example.

The wireless transmission unit 250 converts the packet data into a wireless signal according to the transmission availability of the dynamic carrier sense operation unit 240, and transmits the wireless signal to the terminal 300 under control.

The control station-side transmission unit 260 transmits the received power value and the like received from the wireless reception unit 230 to the central control station 100.

Configuration Example of Terminal

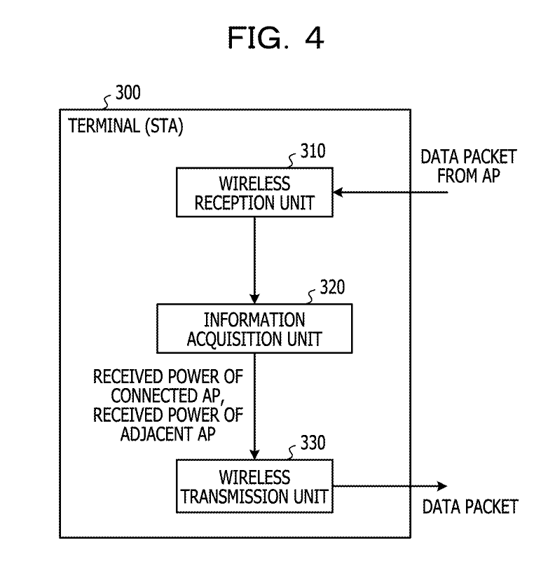

FIG. 4 is a diagram illustrating a configuration example of the terminal 300. The terminal 300 includes a wireless reception unit 310, an information acquisition unit 320, and a wireless transmission unit 330.

The wireless reception unit 310 receives a wireless signal transmitted from the AP 200, and extracts packet data and the like from the received wireless signal. The wireless reception unit 310 outputs the extracted packet data to the information acquisition unit 320. In addition, the wireless reception unit 310 measures the received power value based on the received wireless signal. In this case, the wireless reception unit 310 is able to measure the received power value of the wireless signal transmitted from the AP 200-1 under control which it performs wireless communication, or measure the received power value of the wireless signal transmitted from the AP 200-2 adjacent to the AP 200-1. The wireless reception unit 310 outputs the acquired received power value to the information acquisition unit 320.

The information acquisition unit 320 receives the received power value measured in the wireless reception unit 310, identifies an AP 200 for which the received power value is, based on the packet information or the like received from the wireless reception unit 310, and adds AP identification information to each received power value. The information acquisition unit 320 outputs the received power value and the AP identification information to the wireless transmission unit 330.

The wireless transmission unit 330 generates a data packet for the received power value and the AP identification information received from the information acquisition unit 320, converts the data packet into a wireless signal, and transmits the converted wireless signal to the AP 200-1.

Operation Example

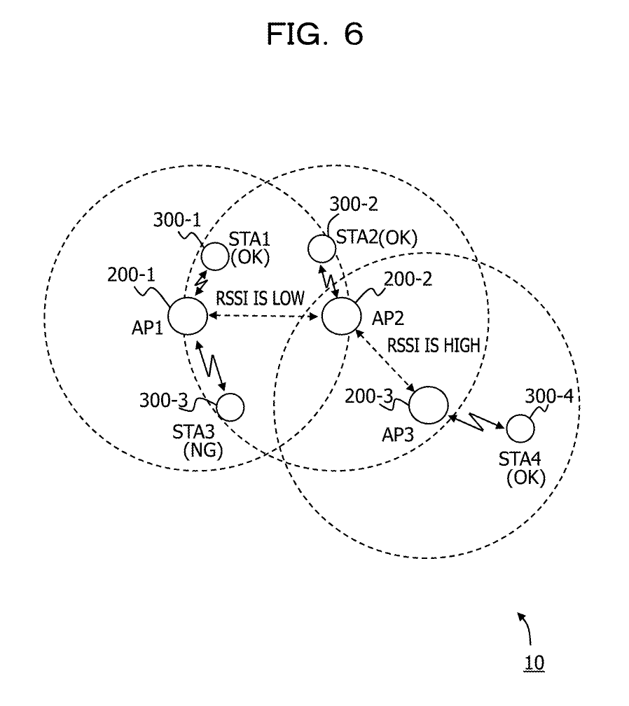

Next, an operation example will be described. FIG. 6 illustrates a configuration example of the wireless communication system 10 used in the operation example. The example of the wireless communication system 10 illustrated in FIG. 6 represents an example in which an AP 200-3 is further provided and performs wireless communication with the terminal 300-4.

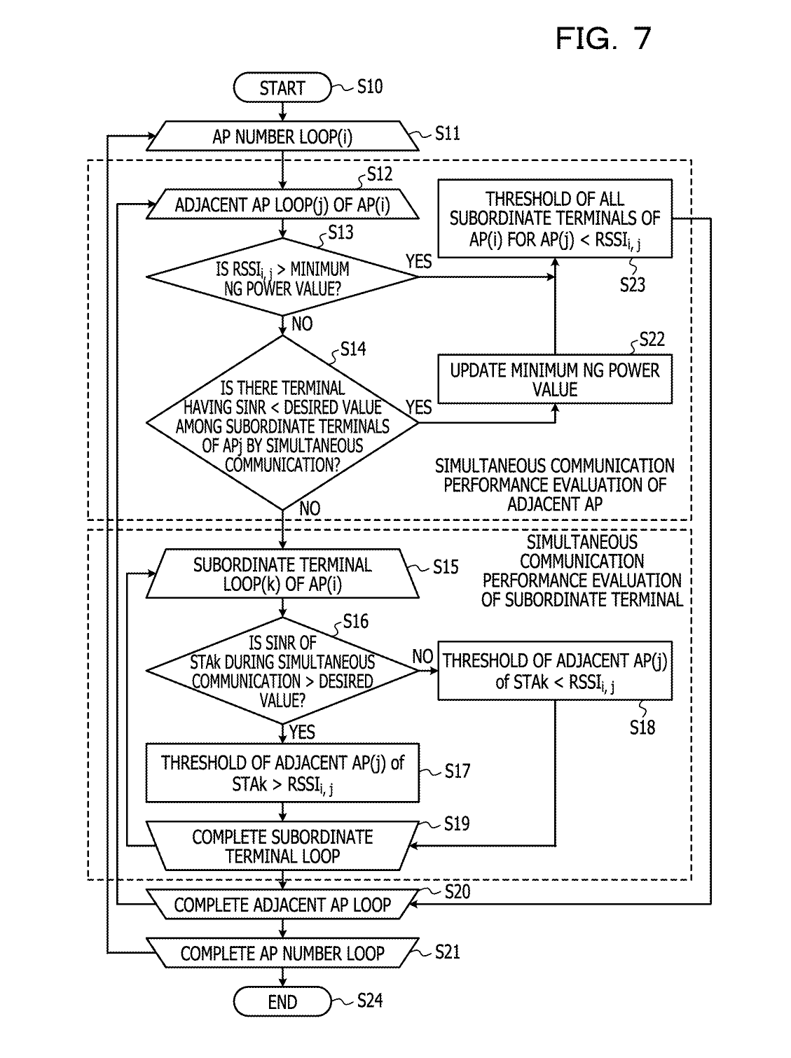

FIG. 7 is a flowchart illustrating an operation example of calculating a carrier sense threshold. The carrier operation example illustrated in FIG. 7 is performed by, for example, the carrier sense threshold calculation unit 130 of the central control station 100. The flowchart of FIG. 7 will be described by appropriately using FIG. 6.

The flowchart illustrated in FIG. 7 is divided into two blocks: simultaneous communication performance evaluation of an adjacent AP (S12 to S14, and S22 to S23) and simultaneous communication performance evaluation of a subordinate terminal (S15 to S19).

In the simultaneous communication performance evaluation of the adjacent AP, the central control station 100 evaluates, for example, whether or not the adjacent AP 200-2 and the AP 200-1 can perform simultaneous communication while the AP 200-1 does not interfere in the subordinate terminal 300 of the adjacent AP 200-2. On the other hand, in the simultaneous communication performance evaluation of a subordinate terminal, when it is evaluated that simultaneous communication is possible, the central control station 100 sets, for example, a carrier sense threshold for each adjacent AP 200-2, with respect to each subordinate terminal 300 of the AP 200-1. Each process will be described below.

Upon starting the process (S10), the central control station 100 performs the following process for each AP(i) (S11). For example, the carrier sense threshold calculation unit 130 sets i=1 and performs the following process for the AP 200-1 (=AP(1)).

Next, the central control station 100 performs the simultaneous communication performance evaluation of an adjacent AP (S12 to S14, and S22 to S23). In the example of FIG. 6, the AP 200-2 and the AP 200-1 are adjacent to each other and the AP 200-3 and the AP 200-3 are adjacent to each other, but the AP 200-1 and the AP 200-3 are not adjacent to each other. The central control station 100 performs the simultaneous communication performance evaluation for the adjacent AP 200-2.

That is, the central control station 100 sets j=2, and performs the following process for the adjacent AP 200-2 (=AP(2)).

Next, the central control station 100 determines whether or not a received signal strength indicator (RSSI)_{i, j} is greater than the minimum NG power value (S13). The RSSI_{i, j} represents, for example, a received power value between adjacent APs, and represents a received power value received from the AP(j) by the AP(i). For example, in the example of FIG. 6, the carrier sense threshold calculation unit 130 performs a process by comparing the received power value received from the adjacent AP 200-2 by the AP 200-1 with the minimum NG power value. At this stage, since the minimum NG power value is not calculated, the carrier sense threshold calculation unit 130 shifts the process to S14.

In S14, the central control station 100 determines whether there is a terminal 300 whose a signal to interference plus noise ratio (SINR) is less than a desired value by simultaneous communication among subordinate terminals of the adjacent AP(j). For example, the carrier sense threshold calculation unit 130 calculates the SINR for the subordinate terminal 300-2 of the adjacent AP 200-2, with the received power value of the signal received from the AP 200-2 as S, the received power value of the signal received from the AP 200-1 as I, and the noise power of the terminal 300-2 as N. In this case, the SINR represents, for example, a ratio of the received power value (S) for the AP 200-2 to the received power value (I) for the AP 200-1, in the terminal 300-2. The carrier sense threshold calculation unit 130 can calculate an SINR based on the received power values collected from the respective APs 200-1 and 200-2.

In this process (S14), when the SINRs of all the terminals 300-2 under control of the adjacent AP 200-2 are equal to or greater than a desired value (or when the desired value is satisfied) (no in S14), it is determined that the AP 200-1 and the adjacent AP 200-2 can perform simultaneous communication, and the process proceeds to simultaneous performance evaluation of subordinate terminals.

On the other hand, if the SINR of even one of all the subordinate terminals 300-2 of the adjacent AP 200-2 does not satisfy the desired value (yes in S14), it is determined that the adjacent AP 200-2 and the AP 200-1 may not perform simultaneous communication, and the process of S22 to S23 is performed.

In the example of FIG. 6, it is assumed that the terminal 300 under control of the adjacent AP 200-2 is only the terminal 300-2, and the SINR of the terminal 300-2 is equal to or greater than the desired value. Therefore, the carrier sense threshold calculation unit 130 determines that all the terminals 300-2 under control of the adjacent AP 200-2 can perform simultaneous communication with the AP 200-1 (no in S14), and shifts the process to the simultaneous communication performance evaluation of a subordinate terminal.

Returning to FIG. 7, next, the central control station 100 performs the following process for each terminal 300 under control of the AP(1) (S15). For example, the carrier sense threshold calculation unit 130 sets k=1 so as to process all the terminals 300-1 and 300-3 under control of the AP 200-1, and performs the following process sequentially from the terminal 300-1.

Next, the central control station 100 determines whether or not the SINR of the terminal 300-1 (STA 1) during simultaneous communication is larger than the desired value (or whether or not the desired value is satisfied) (S16). For example, the carrier sense threshold calculation unit 130 calculates the SINR, with the received power value of the AP 200-1 as S and the received power value of the adjacent AP 200-2 as I. In this case, the SINR represents, for example, a ratio of the received power value (S) for the AP 200-1 to the received power value (I) for the AP 200-2, in the terminal 300-1. For example, the carrier sense threshold calculation unit 130 determines whether or not the terminal 300-1 under control of the AP 200-1 can perform simultaneous communication with the adjacent AP 200-2. In addition, the “desired value” in S16 may be the same value as or may be a different value from the “desired value” in S14.

When the SINR of the terminal 300-1 is greater than the desired value (or when the desired value is satisfied) (yes in S16), the central control station 100 calculates the carrier sense threshold for the adjacent AP(j) of the terminal 300-1 to a value larger than RSSI_{i, j} (S17).

For example, it is assumed that the SINR of the terminal 300-1 is larger than the desired value. That is, even if signals from the AP 200-1 and the adjacent AP 200-2 are received at the same time, it is assumed the terminal 300-1 can normally receive the signal from the AP 200-1 without an interference of the signal from the adjacent AP 200-2. In this case, the carrier sense threshold calculation unit 130 sets the carrier sense threshold for the adjacent AP 200-2 of the terminal 300-1 to a value larger than RSSI_{1, 2}. In this case, similar to “A” in FIG. 5A, even if the AP 200-1 receives signals from the adjacent AP 200-2, the received power value is less than the carrier sense threshold, and can communicate with the terminal 300-1 under control.

Next, the central control station 100 repeats the above-described process for all the terminals 300 under control of the AP 200(i) (a loop from S15 to S19).

In the example of FIG. 6, the carrier sense threshold calculation unit 130 compares the SINR and the desired value, with respect to the subordinate terminal 300-3 of the AP 200-1 (S16). In this case, it is assumed that the SINR (S is the AP 200-1 and I is the adjacent AP 200-2) of the subordinate terminal 300-3 is equal to or less than the desired value. That is, even if signals from the AP 200-1 and the adjacent AP 200-2 are received at the same time, it is assumed that the terminal 300-2 may not normally receive the signal from the AP 200-1 due to the interference of the signal from the adjacent AP 200-2. In this case, the carrier sense threshold calculation unit 130 sets the carrier sense threshold for the adjacent AP 200-2 of the terminal 300-2 to a value less than RSSI_{1, 2}. In this case, similar to “B” in FIG. 5A, if the AP 200-1 receives signals from the adjacent AP 200-2, the carrier sense threshold is less than the received power value of the signal. Therefore, the AP 200-1 may not communicate while the adjacent AP 200-2 is communicating, and simultaneous communication becomes impossible.

FIG. 8A illustrates examples of a carrier sense threshold for the AP 200-1. The example of FIG. 8A represents an example in which there are two subordinate terminals 300-1 and 300-3, but if there are three subordinate terminals, a carrier sense threshold is set for each subordinate terminal. If there are a plurality of adjacent APs 200, the subordinate terminal 300 sets a carrier sense threshold for each adjacent AP 200.

Returning to FIG. 7, if the simultaneous communication performance evaluation of a subordinate terminal for all terminals 300 under control of the AP(1) is performed, the central control station 100 determines whether or not the adjacent AP loop for the AP(1) is completed (S20). In the example of FIG. 6, since the adjacent AP of the AP 200-1 is only the AP 200-2, the process for all adjacent APs 200-3 of the AP 200-1 is completed.

Upon completion of the process for all adjacent APs to the AP(1), the central control station 100 confirms whether the process is performed for all the APs 200 (S21). In the example of FIG. 6, the central control station 100 completes the process for the AP 200-1, and thereafter performs the process for the AP 200-2.

When the process is not completed for all the APs 200, the central control station 100 increments “i” to shift the process to S11, and repeats the above-described process (a loop from S11 to S21).

In the example of FIG. 6, the central control station 100 performs the following process for the AP 200-2 by setting i=2 (S11).

Next, the central control station 100 performs simultaneous communication performance evaluation of the adjacent APs, for the adjacent AP 200-1 of the AP 200-2 by setting j=1. The central control station 100 determines whether or not the received power value SSI_{2, 1} from the adjacent AP 200-1 of the AP 200-2 is larger than the minimum NG power value (S13), but the minimum NG power value is not set, such that the process is proceeds to S14.

In S14, the central control station 100 determines whether or not there is a terminal whose the SINR is less than the desired value when the adjacent AP 200-1 and the AP 200-2 perform simultaneous communication, for the subordinate terminals 300-1 and 300-3 of the adjacent AP 200-1 (S14).

As in the above case, it is assumed that the SINR (S is the received power value for the AP 200-1, and I is the received power value for the AP 200-2) of the terminal 300-1 is larger than the desired value, and the SINR of the terminal 300-3 is less than the desired value.

In this case, since all the terminals 300-1 and 300-3 under control of the adjacent AP 200-1 do not satisfy the desired value (yes in S14), the central control station 100 updates (or sets) the minimum NG power value (S22). For example, the carrier sense threshold calculation unit 130 detects that the SINR of the terminal 300-1 under control of the adjacent AP 200-1 is less than the desired value (yes in S14), and sets the received power value RSSI_{2, 1} for the AP 200-1 in the AP 200-2 as the minimum NG power value (S22).

Next, the central control station 100 sets the carrier sense threshold for the adjacent AP 200-1 of all terminals 300-2 under control of the AP 200-2 to a value less than the received power value RSSI_{2, 1} (S23). For example, the carrier sense threshold calculation unit 130 sets the carrier sense threshold so that the AP 200-2 does not communicate with the terminal 300-2 when the AP 200-1 is communicating. In the example of FIG. 5A, assuming that the received power value from the adjacent AP 200-1 in the AP 200-2 is “B”, the carrier sense threshold can be set such that the AP 200-1 and the AP 200-2 do not perform simultaneous communication, by lowering the carrier sense threshold than “B”. Since the terminal 300-3 under control of the adjacent AP 200-1 may not normally receive the signal from the adjacent AP 200-1 due to the interference of the signal from the AP 200-2 even when performing simultaneous communication. In order to protect the terminal 300-3 from simultaneous communication, the carrier sense threshold is set such that simultaneous communication with the AP 200-2 is not performed.

FIG. 8B illustrates examples of a carrier sense threshold for the AP 200-2. With respect to the subordinate terminal 300-2 (STA 2), the carrier sense threshold is set so that simultaneous communication with the adjacent AP 200-1 (AP 1) is not performed.

Referring to FIG. 7, if a carrier sense threshold for the adjacent AP 200-1 of the terminal 300-3 under control of the AP 200-2 is set (S23), the central control station 100 performs simultaneous communication performance evaluation of the adjacent AP for the next adjacent AP 200-3 (j=3) (S20, S12).

In this case, the central control station 100 determines whether or not the received power value RSSI_{2, 3} for the adjacent AP 200-3 of the AP 200-2 is larger than the minimum NG power value (=received power value RSSI_{2, 1}) (S13). In the example of FIG. 6, it is assumed that received power value RSSI_{2, 3} for the AP 200-3 is larger than the received power value RSSI_{2, 1} for the AP 200-1, in the AP 200-2.

Accordingly, the central control station 100 determines “yes” in S13, and sets the carrier sense threshold for the adjacent AP 200-3 of all the terminals 300-2 under control of the AP 200-2 to a value less than RSSI_{2, 3} (S23). That is, the carrier sense threshold calculation unit 130 sets the carrier sense threshold so that the AP 200-2 does not communicate with the terminal 300-2 when the AP 200-3 is communicating.

That is, the central control station 100 sets the received power value RSSI_{2, 1} from the adjacent AP 200-1, which is not allowed to perform simultaneous communication, as the minimum NG power value, in order to protect the adjacent AP 200-1 which is not allowed to perform simultaneous communication. The central control station 100 does not allow the AP 200-2 to perform simultaneous communication with the adjacent AP 200-3 having the received power value between APs larger than the minimum NG power value so as to protect the terminal 300-3 of the adjacent AP 200-1 which is not allowed to perform simultaneous communication. FIG. 8B illustrates an example of a carrier sense threshold for the adjacent AP 200-3 of the terminal 300-2 under control of the AP 200-2.

Returning to FIG. 7, when the central control station 100 ends the process for all the adjacent APs 200-1 and 200-3 of the AP 200-2 (S20), the central control station 100 repeats the above-described process for the AP 200-3 (a loop of S21 and S11). A description of the AP 200-3 is omitted.

As described above, the central control station 100 transmits the calculated carrier sense threshold to each AP 200. Each AP 200 performs carrier sense using the received carrier sense threshold. An operation example in each AP 200 will be described below.

Operation Example of AP

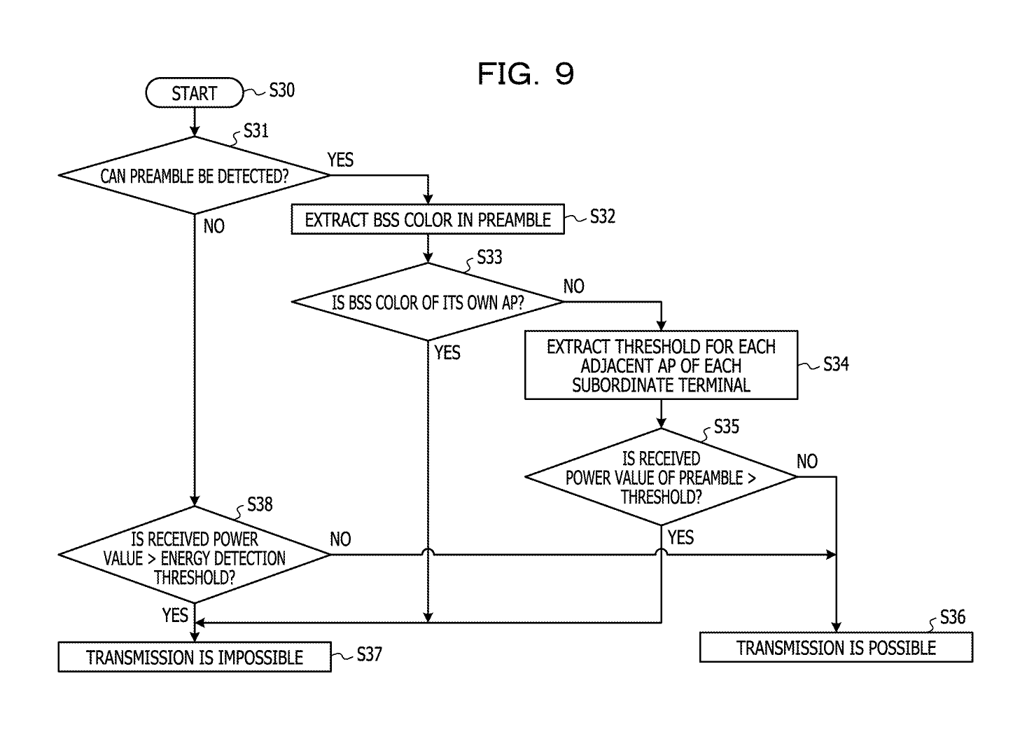

FIG. 9 is a flowchart illustrating an operation example in the AP 200. Each process illustrated in FIG. 9 is performed in, for example, the dynamic carrier sense operation unit 240 of the AP 200. It is assumed that the AP 200 stores the carrier sense threshold received from the central control station 100 in the carrier sense threshold storage unit 220.

Upon starting the process (S30), the AP 200 receives the signal transmitted from the adjacent AP or the subordinate terminal 300, and determines whether or not the preamble signal can be detected from the received signal during the carrier sense period (S31). For example, the wireless reception unit 230 determines this process depending on whether or not the preamble signal can be detected from the received wireless signal.

When detecting the preamble (yes in S31), the AP 200 extracts a basic service set (BSS) color included in the preamble signal. The BSS color is, for example, identification information for identifying the AP 200. For example, the wireless reception unit 230 extracts the BSS color and outputs the BSS color to the dynamic carrier sense operation unit 240.

Next, the AP 200 determines whether the BSS color is the BSS color of the AP 200 (S33).

When the extracted BSS color is the BSS color of its own station (yes in S33), the AP 200 determines that transmission is impossible (S37). In this case, since the AP 200 does not perform transmission when the AP 200 receives the wireless signal of its own AP 200 station from the subordinate terminal 300 and the AP 200 performs reception, the AP 200 determines that transmission is impossible. For example, if it is checked that the BSS color received from the wireless reception unit 230 is the BSS color of its own AP 200, the dynamic carrier sense operation unit 240 determines that transmission is impossible and notifies the wireless transmission unit 250 that transmission is impossible. The wireless transmission unit 250 does not perform the transmission process.

On the other hand, when the extracted BSS color is not the BSS color of its own station (NO in S33), the AP 200 reads the threshold for each adjacent AP of each subordinate terminal, from the carrier sense threshold storage unit 220 (S34). In this case, for example, the wireless signal received by the AP 200-1 is not the wireless signal addressed to the own AP 200-1 but the wireless signal transmitted by the adjacent AP 200-2.

For example, the dynamic carrier sense operation unit 240 reads the carrier sense threshold from the carrier sense threshold storage unit 220 in the following manner. That is, when the packet data addressed to the subordinate terminal 300-1 or the subordinate terminal 300-2 is stored in a buffer or the like, the dynamic carrier sense operation unit 240 reads the packet data from the buffer. The dynamic carrier sense operation unit 240 reads the destination of the packet data. In addition, the dynamic carrier sense operation unit 240 determines adjacent APs between which the BSS color of the received signal is, based on a table or the like stored in the buffer. The dynamic carrier sense operation unit 240 sets the destination of the packet data stored in the buffer as “subordinate terminal”, and the adjacent AP determined from the BSS color as “adjacent AP”, and reads the carrier sense threshold corresponding to “subordinate terminal” and “adjacent AP” from the carrier sense threshold storage unit 220.

By using the read carrier sense threshold, when the received power value of the preamble is larger than the carrier sense threshold (yes in S35), the AP 200 determines that transmission is impossible (S37); and when the received power value is equal to or less than the carrier sense threshold (no in S35), the AP 200 determines that transmission is possible (S36). For example, the dynamic carrier sense operation unit 240 compares the extracted carrier sense threshold and the received power value received from the wireless reception unit 230 to determine whether transmission is possible or not, and outputs the determined result to the wireless transmission unit 250. According to the determined result, the wireless transmission unit 250 can transmit or not transmit a wireless signal.

On the other hand, when the preamble may not be detected (no in S31), the AP 200 determines the signal as a wireless LAN signal, for example, a Bluetooth (registered trademark) signal, and compares the received power value and the energy detection threshold (S38). The energy detection threshold is, for example, a threshold defined in IEEE802. 11ac and the like and is a threshold for avoiding a collision with a signal of another wireless system. When the received power value of the received signal is larger than the energy detection threshold (yes in S38), the AP 200 determines that transmission is impossible (S37); and when the received power value is equal to or less than the energy detection threshold (no in S38), the AP 200 determines that transmission is possible (S36). For example, the dynamic carrier sense operation unit 240 reads the energy detection threshold stored in the memory and compares it with the received power value received from the wireless reception unit 230, thereby determining whether transmission is possible or not.

As described above, in the first embodiment, the central control station 100 sets a carrier sense threshold for the AP 200, for each pair of the terminal 300 under control of the AP 200-1 and the adjacent AP 200-2 adjacent to the AP 200. That is, the central control station 100 sets the carrier sense threshold for the subordinate terminal 300-2 of the adjacent AP 200-2, which interferes in the terminal 300 under control of the AP 200-1 by the simultaneous communication, such that the simultaneous communication with the AP 200 is not performed (S14 and S23 in FIG. 7). On the other hand, when the simultaneous communication with the adjacent AP 200-2 does not interfere, the central control station 100 sets the carrier sense thresholds with respect to the terminals 300-1 and 300-3 under control of the AP 200-1 and the adjacent AP, for each pair of the terminals 300-1 and 300-3 and the adjacent AP (S16 to S18 in FIG. 7).

Accordingly, even when simultaneous communication with the adjacent AP 200-2 is not performed, the AP 200-1 can also communicate with the terminal 300-1 under control of the AP 200-1 (S17). Therefore, in the present wireless communication system 10, as compared with the case where communication with the subordinate terminal 300 is not performed since simultaneous communication may not be performed between the AP 200-1 and the adjacent AP 200-2, the opportunity for transmission of the AP 200-1 increases and the throughput of the entire system can be improved.

### Second Embodiment

Next, a second embodiment will be described. In the first embodiment, an example is described in which the central control station 100 sets the carrier sense threshold for the AP 200-1 for each pair of the subordinate terminal of the AP 200-1 and the adjacent AP 200-2. The second embodiment represents an example in which the central control station 100 sets a carrier sense threshold for each pair of the subordinate terminals 300-1 and 300-3 of the AP 200-1 and the subordinate terminal 300-2 of the adjacent AP 200-2.

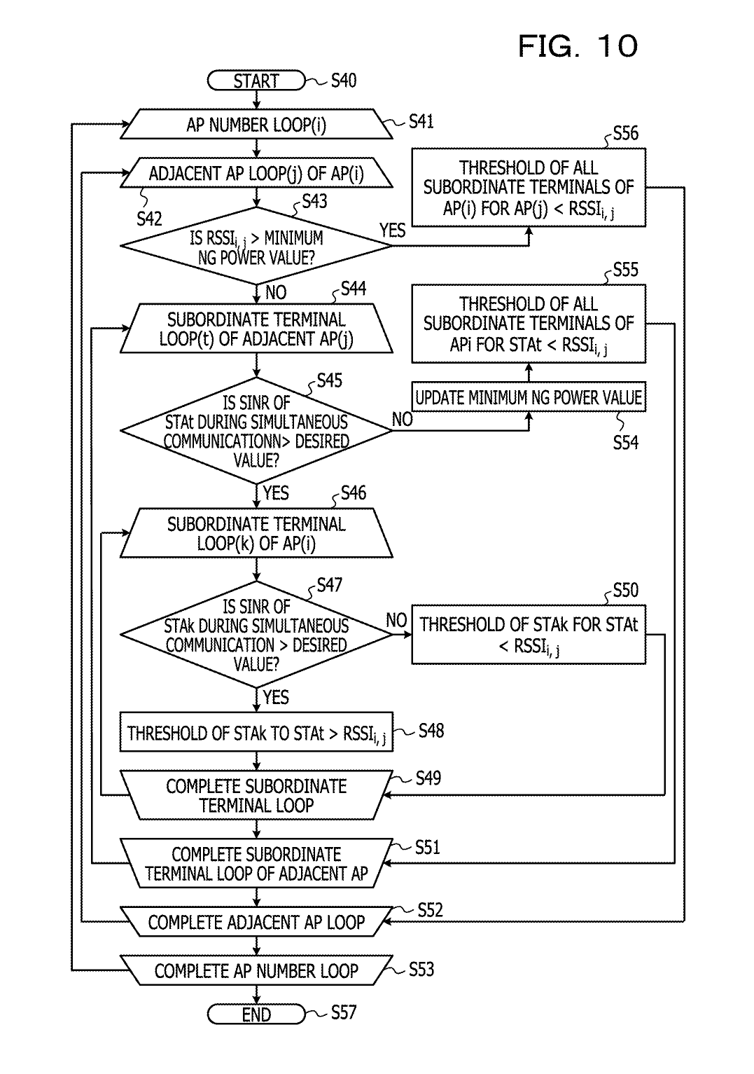

FIG. 10 is a flowchart illustrating an operation example in the second embodiment. The flowchart illustrated in FIG. 10 is performed, for example, in the carrier sense threshold calculation unit 130 of the central control station 100. The example in FIG. 6 will be described as in the first embodiment.

Upon starting the process (S40), the central control station 100 sets i=1 and performs the following process for the AP(1) (=AP 200-1) (S41).

Next, the central control station 100 sets j=1 and performs the following process for the adjacent AP(1) (=AP 200-2) of the AP 200-1 (S42).

Next, the central control station 100 determines whether or not the received power value RSSI_{1, 2} between adjacent APs is larger than the minimum NG power value (S43). Since the minimum NG power value is not set at this stage, the process proceeds to S44.

In S44, the central control station 100 sets t=1 and performs the following process for the terminal STA1 (=terminal 300-2) under control of the adjacent AP 200-2 (S44).

Next, the central control station 100 determines whether or not the SINR of the terminal 300-2 at the time of performing simultaneous communication with the AP 200-1 is larger than the desired value (S45). For example, the carrier sense threshold calculation unit 130 calculates the SINR in the terminal 300-2, with the received power value for the adjacent AP 200-2 as S and the received power value for the AP 200-1 as I. In this case, it is assumed that the SINR of the terminal 300-2 is larger than the desired value. That is, even if the terminal 300-2 under control of the adjacent AP 200-2 performs simultaneous communication with the AP 200-1, it is assumed that the terminal 300-2 can communicate with the adjacent AP 200-2 without an interference of the signal from the adjacent AP 200-1.

When the SINR of the terminal 300-2 when performing simultaneous communication with the AP 200-1 is larger than the desired value (yes in S45), the central control station 100 sets k=1, and performs the following process for the subordinate terminal STA 1 (=terminal 300-1) of the AP 200-1 (S46).

Next, the central control station 100 determines whether or not the SINR when the subordinate terminal 300-1 of the AP 200-1 performs simultaneous communication with the adjacent AP 200-2 is larger than the desired value (S47). For example, the carrier sense threshold calculation unit 130 calculates the SINR in the terminal 300-1, with the received power value for the AP 200-1 as S and the received power value for the adjacent AP 200-2 as I. Here, it is assumed that the SINR of the terminal 300-1 is larger than the desired value.

When the SINR of the terminal 300-1 is larger than the desired value (yes in S47), the central control station 100 sets the carrier sense threshold for the terminal 300-2 under control of the adjacent AP 200-2 of the terminal 300-1 to a value larger than the received power value SSI_{1, 2} between adjacent APs (S48). As described above, in this second embodiment, the central control station 100 sets a carrier sense threshold for each pair of the subordinate terminal 300-1 of the AP 200-1 and the subordinate terminal 300-2 of the adjacent AP 200-2.

Next, the central control station 100 increments “k” and repeats the process of S46 to S48 for the other terminals 300 under control of the AP 200-1. In the example of FIG. 6, the other terminals 300 under control of the AP 200-1 are only the terminal 300-3, and the process of S46 to S48 is repeated for the terminal 300-3. In this case, it is assumed that the SINR of the terminal 300-3 is less than the desired value.

When the SINR of the terminal 300-3 is less than the desired value (no in S47), the central control station 100 sets the carrier sense threshold for the subordinate terminal 300-2 of the adjacent AP 200-2 of the terminal 300-3 to a value less than the received power value SSI_{1, 2} between adjacent APs (S50). In this case, simultaneous communication is not performed between the AP 200-1 and the subordinate terminal 300-3, and the adjacent AP 200-2 and its subordinate terminal 300-2. This is because the SINR of the terminal 300-3 is less than the desired value, and the terminal 300-3 may not normally receive the signal from the AP 200-1 due to an interference of the signal from the adjacent AP 200-2, even if the simultaneous communication is performed.

Upon completion of the process for all the subordinate terminals 300-1 and 300-3 of the AP 200-1 (S49), the central control station 100 increments “t”, and repeats the process from S44 to S50 for other subordinate terminals other than the subordinate terminal 300-2 of the adjacent AP 200-2. In the example of FIG. 6, since the subordinate terminal of the adjacent AP 200-2 is only the terminal 300-2, the loop process of the adjacent AP subordinate terminal (S44 to S51) is completed.

Upon completion of the loop process of the adjacent AP subordinate terminal, the central control station 100 repeats the process of S42 to S52 and S54 to S56 for other adjacent APs other than the adjacent AP 200-2 (S52). In the example of FIG. 6, since the adjacent AP of the AP 200-1 is only the adjacent AP 200-2 and there is no other adjacent AP, the adjacent AP loop is completed.

Upon completion of the process for all adjacent APs of the AP 200-1 (S52), the central control station 100 increments “i”, and repeats the process from S42 to S56 for the AP(2) (=AP 200-2).

The process for the AP 200-2 is as follows. That is, since the minimum NG power value is not set, the central control station 100 determines whether or not the SINR during simultaneous communication is larger than the desired value, with respective to the subordinate terminal 300-1 of the adjacent AP 200-1 of the AP 200-2 (S45). In this case, the central control station 100 assumes that the SINR of the terminal 300-1 is larger than the desired value (yes in S45) and the SINR of the subordinate terminal 300-2 of the AP 200-2 is also larger than the desired value (yes in S47). In this case, the central control station 100 sets the carrier sense threshold for the terminal 300-1 of the terminal 300-2 to a value larger than the received power value SSI_{2, 1} between adjacent APs (S48). That is, even if simultaneous communication is performed between AP 200-2 and its subordinate terminal 300-3, and the adjacent AP 200-1 and its subordinate terminal 300-1, communication with the AP becomes possible without an interference of signals from other APs.

On the other hand, with respect to the subordinate terminal 300-3 of the adjacent AP 200-1, when the SINR is less than the desired value (no in S45), the minimum NG power value is set to the received power value SSI_{2, 1} between the adjacent APs (S54). The central control station 100 sets the carrier sense threshold for the subordinate terminal 300-3 of the adjacent AP 200-1 of all the terminals 300-2 under control of the AP 200-2 to a value less than the received power value SSI_{2, 1} between the adjacent APs (no in S47, and S50). That is, simultaneous communication is not performed between the AP 200-2 and all the terminals 300-2 under its control, and the adjacent AP 200-1 and its subordinate terminal 300-3. When such simultaneous communication is performed, this is because the terminal 300-3 may not be able to communicate with the AP 200-1 due to an interference of the signal from the AP 200-2.

The central control station 100 completes the process for the subordinate terminals 300-1 and 300-3 of the adjacent AP 200-1 of the AP 200-2 (S51), and performs the process for the subordinate terminal 300-4 of the adjacent AP 200-3.

In this case, the central control station 100 assumes that the minimum NG power value is set and the received power value RSSI_{2, 3} between the adjacent APs is larger than the minimum NG power value (=RSSI_{2, 1}). In this case, the central control station 100 determines yes in S43, sets the carrier sense threshold for all the terminals 300-4 under control of the AP 200-3 of all the terminals 300-2 under control of the AP 200-2 to a value less than RSSI_{2, 3} (S56). That is, the central control station 100 sets the carrier sense threshold such that simultaneous communication is impossible for the terminal 300-2 and the terminal 300-4. Also in this case, the central control station 100 protects the subordinate terminal 300-3 of the AP 200-1 for which the AP 200-1 and the AP 200-2 are not able to perform simultaneous communication.

The central control station 100 completes the process for all the subordinate terminals 300-3 of the adjacent AP 200-3 (S51), completes the process for the adjacent APs 200-1 and 200-3 (S52), and increments “i”, and performs the process for the AP 200-3. After that, since the process described above is repeated, the description thereof will be omitted.

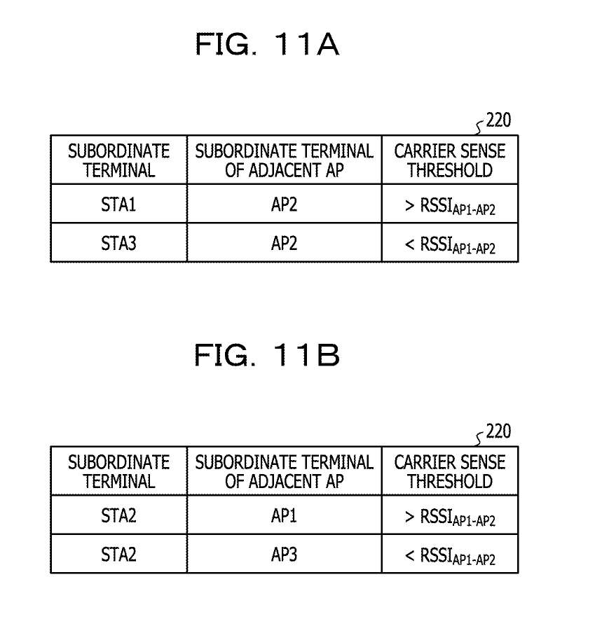

FIG. 11A and FIG. 11B respectively illustrate the setting examples of the carrier sense thresholds for the AP 200-1 and the AP 200-2. As illustrated in FIG. 11A and FIG. 11B, the central control station 100 sets a carrier sense threshold for each pair of the subordinate terminal 300-1 of the AP 200-1 and the subordinate terminal 300-2 of the adjacent AP 200-2. The central control station 100 transmits the set carrier sense threshold to the AP 200. FIG. 11A and FIG. 11B represent examples of the carrier sense thresholds stored in the carrier sense threshold storage units 220 of the respective AP 200-1 and 200-2.

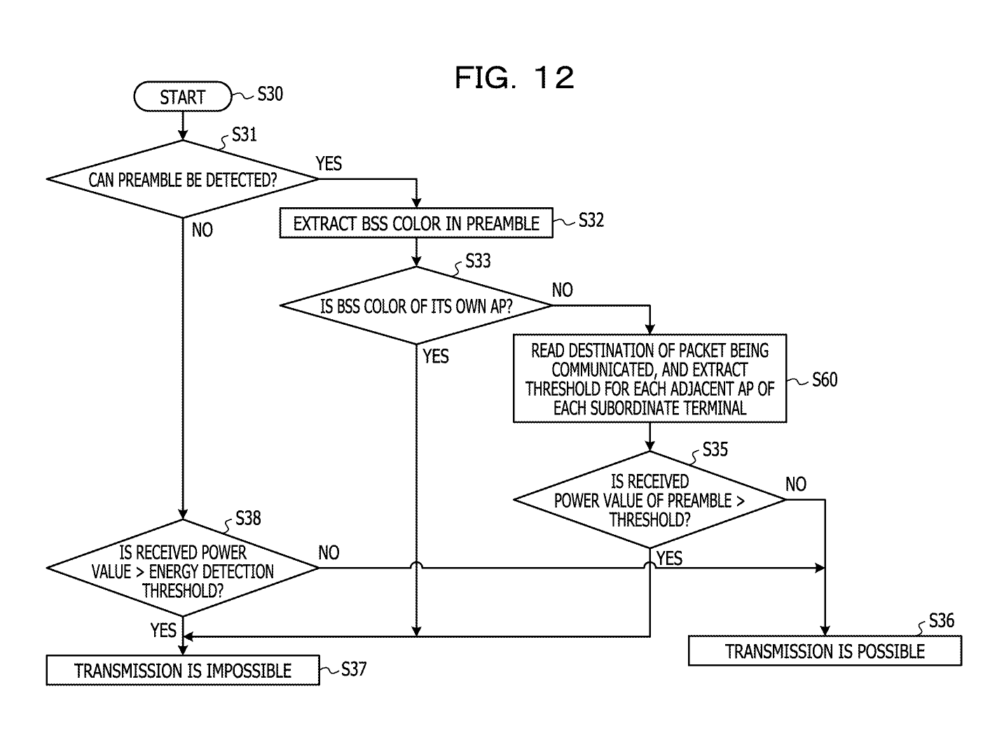

FIG. 12 is a flowchart illustrating an operation example of the AP 200 that receives the carrier sense threshold. In FIG. 12, the same process as in the first embodiment is denoted by the same reference numeral.

In this case, the carrier sense threshold is set for a pair of the subordinate terminals 300-1 and 300-3 of the AP 200-1 and the subordinate terminal 300-2 of the adjacent AP 200-2. Therefore, the dynamic carrier sense operation unit 240 reads, for example, the carrier sense threshold from the carrier sense threshold storage unit 220 in the following manner.

That is, if the AP 200-2 receives the signal transmitted from the AP 200-1, the dynamic carrier sense operation unit 240 receives the signal which is transmitted from the other AP 200-1 and is not addressed to the AP 200-2 (no in S33). In this case, the dynamic carrier sense operation unit 240 receives the packet information extracted from the received signal from the wireless reception unit 230, and extracts the destination (for example, the terminal 300-1) of the in-communication packet. Further, when the AP 200-2 transmits a packet to its own subordinate terminal 300-2, the dynamic carrier sense operation unit 240 reads the destination (for example, the terminal 300-2) from the packet stored in the buffer. The dynamic carrier sense operation unit 240 specifies “subordinate terminal” corresponding to the destination (for example, the terminal 300-2) read from the packet stored in the buffer, and “adjacent AP subordinate terminal” corresponding to the destination (for example, the terminal 300-1) specified from the in-communication packet. The dynamic carrier sense operation unit 240 reads the carrier sense thresholds corresponding to the “subordinate terminal” (for example, STA 2=the terminal 300-2) and “adjacent AP subordinate terminal” (for example, STA 1=the terminal 300-1), from the carrier sense threshold storage unit 220.

Thereafter, similarly to the first embodiment, the dynamic carrier sense operation unit 240 may determine whether transmission is possible or not (S36 and S37) using the read carrier sense threshold, and output the result to the wireless transmission unit 250.

In this second embodiment, the central control station 100 sets a carrier sense threshold for each pair of the subordinate terminal of the AP 200-1 and the subordinate terminal of the adjacent AP 200-2 as a carrier sense threshold for the AP 200-1. In this way, since the carrier sense threshold is set for each of the subordinate terminal and the subordinate terminal of the adjacent AP, the subordinate terminal 300-3 of the AP 200-1 is not allowed to perform simultaneous communication, while the subordinate terminal 300-1 of the AP 200-1 is allowed to perform simultaneous communication. For example, in the example of FIG. 6, the communication between the AP 200-1 and the terminal 300-3 and the communication between the AP 200-2 and the terminal 300-2 are not performed at the same time, while the communication between the AP 200-1 and the terminal 300-1 and the communication between the AP 200-2 and the terminal 300-2 can be performed at the same time. Therefore, in the present wireless communication system 10, simultaneous communication may become possible in some cases as compared with the case where simultaneous communication is not performed, so that the opportunity for transmission of the AP 200-1 increases, and the throughput of the entire system can be improved.

### Third Embodiment

Next, a third embodiment will be described. In the first and second embodiments, the central control station 100 compares the SINR with the desired value to evaluate the performance of simultaneous communication (for example, S14 in FIG. 7). In the third embodiment, the performance of simultaneous communication may be evaluated based on the communication capacity based on SINR.

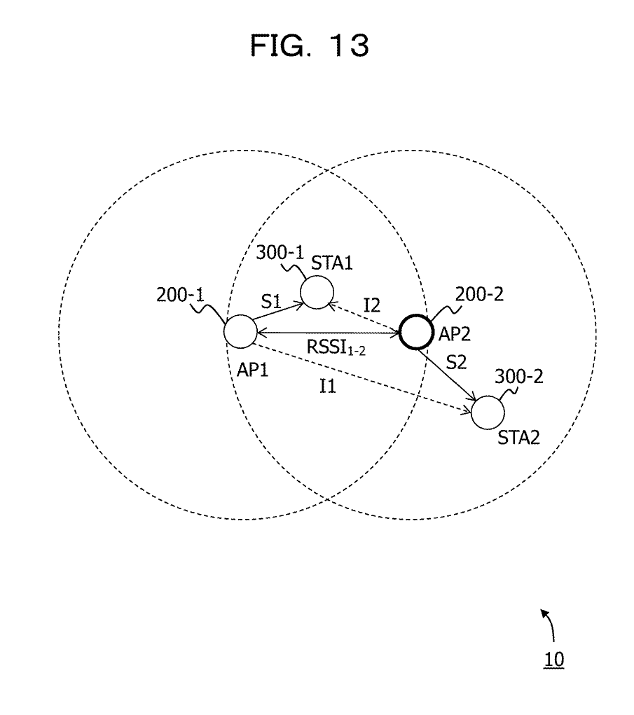

FIG. 13 illustrates a configuration example of the wireless communication system 10 when the AP 200-2 evaluates simultaneous communication performance for the adjacent AP 200-1. This case will be described below as an example.

For example, the carrier sense threshold calculation unit 130 evaluates the performance of simultaneous communication for the subordinate terminal 300-2 (S15 to S19) when the following is satisfied instead of S14 in FIG. 7.

$$C ( \frac{S 1}{N} ) < C ( \frac{S 1}{N + I 2} ) + C ( \frac{S 2}{N + I 1} ) \qquad ( 1 )$$

In Expression (1), C ( ) represents the communication capacity based on the SINR. The whole Expression (1) represents that simultaneous communication is possible, if the communication capacity when the AP 200-1 and the AP 200-2 perform simultaneous communication (the right side of Expression (1)) is larger than the communication capacity when the AP 200-1 alone performs communication (the left side of Expression (1)). In FIG. 7, the carrier sense threshold calculation unit 130 proceeds to S15 when Expression (1) is satisfied, and it proceeds to S22 and proceeds with the process when Expression (1) is not satisfied. Even in S16 of FIG. 7, the carrier sense threshold calculation unit 130 may make a determination by using Expression (1). In this case, in Expression (1), S1 is I1, S2 is I2, I1 is S1, and I2 is S2.

### Fourth Embodiment

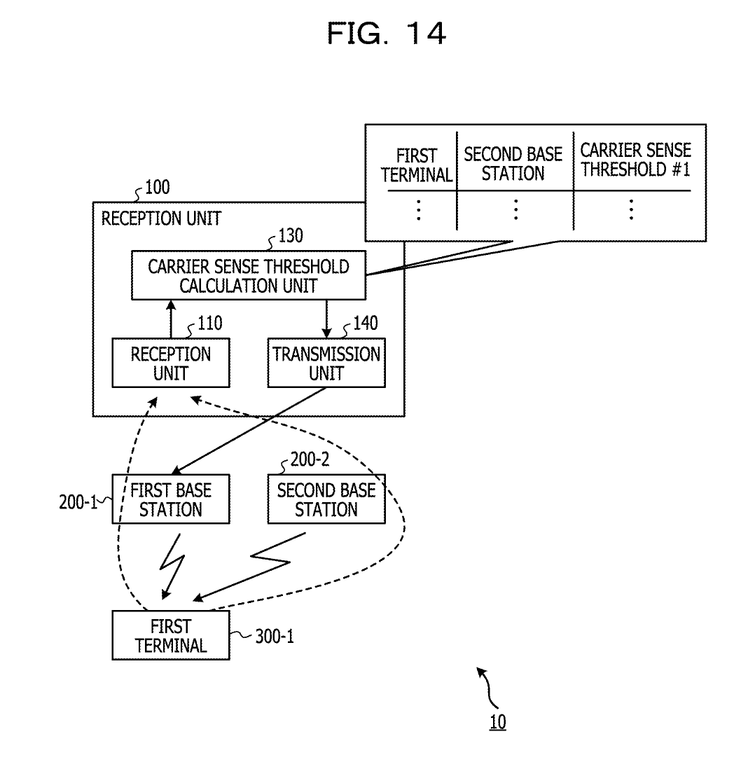

FIG. 14 is a diagram illustrating a configuration example of a wireless communication system 10 in a fourth embodiment. The wireless communication system 10 includes a control apparatus 100, first and second base stations 200-1 and 200-2, and a first terminal 300-1.

The first and second base stations 200-1 and 200-2 are adjacent to each other. Further, the first base station 200-1 has the first terminal 300-1 as a subordinate terminal.

The control apparatus 100 corresponds to, for example, the central control station 100 in the first embodiment. Further, for example, the first base station 200-1 corresponds to the AP 200-1 in the first embodiment, and the second base station 200-2 corresponds to the AP 200-2 in the first embodiment. Further, the first terminal 300-1 corresponds to, for example, the terminal 300-1 in the first embodiment.

The control apparatus 100 includes a reception unit 110, a carrier sense threshold calculation unit 130, and a transmission unit 140.

In the first terminal 300-1, the reception unit 110 receives the first received power value for the first signal received from the first base station 200-1 and the second received power value for the second signal received from the second base station 200-2 adjacent to the first base station 200-1. The reception unit 110 receives the first and second received power values from the first terminal 300-1, through the first base station 200-1 or the second base station 200-2.

The carrier sense threshold calculation unit 130 calculates the carrier sense threshold for each pair of the first terminal 300-1 under control of the first base station and the second base station, based on the received first and second received power values.

The example of FIG. 14 represents an example in which there is one terminal under control of the first base station 200-1. For example, if there are a plurality of terminals such as the first and second terminals, the carrier sense threshold calculation unit 130 calculates the carrier sense threshold also for the pair of the second terminal and the second base station 200-2. Further, with respect to base stations adjacent to the first base station 200-1, if there are a plurality of base stations such as the second and third base stations, the carrier sense threshold calculation unit 130 calculates the carrier sense threshold for each pair of the first terminal 300-1 and the third base station.

The transmission unit 140 transmits the carrier sense threshold to the first base station 200-1.

As described above, in the fourth embodiment, with respect to the first base station 200-1, the carrier sense threshold is set for each pair of the subordinate terminal 300-1 and the second base station 200-2 adjacent to the first base station 200-1. Therefore, the first base station 200-1 may be able to transmit a wireless signal to the first terminal 300-1, by simultaneous communication with the second base station 200-2, depending on the set carrier sense threshold. Alternatively, the first base station 200-1 may not transmit a wireless signal to the other terminal under control of the first base station 200-1 by simultaneous communication with the second base station 200-2, depending on the carrier sense threshold. In a case where simultaneous communication is not possible, as compared to a case where the first base station 200-1 may not transmit a wireless signal to all the terminals under its control, it is possible to transmit a wireless signal like the first terminal 300-1 in some cases, such that the transmission opportunity of the first base station 200-1 increases. This makes it possible to increase the throughput of the entire wireless communication system 10.

### Other Embodiments

In the first to fourth embodiments, a description is made in which the central control station 100 transmits the carrier sense threshold to the AP 200. For example, the AP 200 transmits the carrier sense threshold received from the central control station 100 to the subordinate terminal 300, and the subordinate terminal 300 may communicate with the AP 200 by using the carrier sense threshold. In this case, for example, the subordinate terminal 300 may perform wireless communication in the DL direction using the carrier sense threshold received from the AP 200 or may perform wireless communication in the UL direction. In the latter case, the AP 200 may perform wireless communication with the terminal 300 in the UL direction using the carrier sense threshold received from the central control station.

Further, in the first to fourth embodiments, an example is described in which the central control station 100 calculates the carrier sense threshold and transmits it to the AP 200. For example, the AP 200-1 may calculate the carrier sense threshold, and transmit it to other APs 200-2 and 200-3. In this case, the AP 200-1 may include a reception unit 110, an adjacent AP identification information generation unit 120, a carrier sense threshold calculation unit 130, and a transmission unit 140. The carrier sense threshold calculation unit 130 receives the received power values of the subordinate terminals 300-1 and 300-3 through the reception unit 110, calculates a carrier sense threshold for each pair of the respective subordinate terminals 300-1 and 300-3 and the adjacent AP 200-2, based on the received power value, and transmits it to the adjacent AP 200-2.

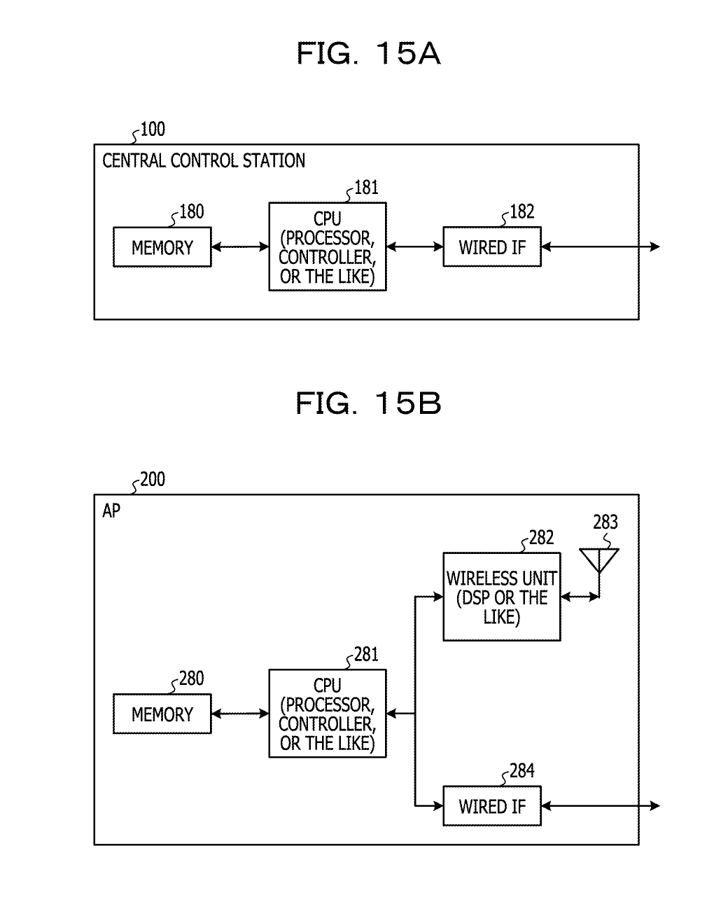

FIG. 14A to FIG. 15 each illustrates a configuration example of a hardware block of each of the devices 100, 200, and 300 in the wireless communication system 10. Even with such a configuration example, it is possible to execute the operations described in the first and second embodiments.

FIG. 14A is a diagram illustrating a hardware configuration example of the central control station 100. The central control station 100 includes a memory 180, a central processing unit (CPU) 181, and a wired interface (IF) 182.

The CPU 181 can realize the functions of the adjacent AP identification information generation unit 120 and the carrier sense threshold calculation unit 130, described in the first and second embodiments, by reading the program stored in the memory 180 and executing the program. The CPU 181 corresponds to, for example, the adjacent AP identification information generation unit 120 and the carrier sense threshold calculation unit 130.

The wired IF 182 is connected to the AP 200 and exchanges the received power value and the carrier sense threshold with the AP 200. The wired IF 182 corresponds to, for example, the reception unit 110 and the transmission unit 140 in the first and second embodiments.

FIG. 14B is a diagram illustrating a hardware configuration example of the AP 200. The AP 200 includes a memory 280, a CPU 281, a wireless unit 282, an antenna 283, and a wired IF 284.

The CPU 281 realizes the function of the dynamic carrier sense operation unit 240 in the first and second embodiments, by reading the program stored in the memory 280 and executing the program. The CPU 281 corresponds to, for example, the dynamic carrier sense operation unit 240.

Further, the memory 280 corresponds to, for example, the carrier sense threshold storage unit 220 in the first embodiment. Further, the wireless unit 282 and the antenna 283 are a portion that performs a process for the wireless signal, and correspond to the wireless reception unit 230 and the wireless transmission unit 250 in the first and second embodiments. Further, the wired IF 284 exchanges the received power value, the carrier sense threshold, and the like with the central control station 100, and corresponds to the control station-side reception unit 210 and the control station-side transmission unit 260 in the first and second embodiments.

FIG. 15 is a diagram illustrating a hardware configuration example of the terminal 300. The terminal 300 includes a memory 380, a CPU 381, a wireless unit 382, and an antenna 383.

The CPU 381 executes the function of the information acquisition unit 320 in the first and second embodiments, by reading the program stored in the memory 380 and executing the program. The CPU 381 corresponds to, for example, the information acquisition unit 320. Further, the wireless unit 382 and the antenna 383 correspond to, for example, the wireless reception unit 310 and the wireless transmission unit 330 in the first and second embodiments.

In addition, in the examples described above, the respective CPUs 181, 281, and 381 may be, for example, a control unit, a controller, or a processor, such as a micro processing unit (MPU), a field-programmable gate array (FPGA), or a digital signal processor (DSP). Further, the wireless units 282 and 382 may be, for example, a control unit, a controller, or a processor, such as a DSP or an FPGA.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus comprising:
a memory; and
a processor coupled to the memory and configured to:
receive a first received power value for a first signal received from a first base station and a second received power value for a second signal received from a second base station adjacent to the first base station in a first terminal under control of the first base station, from the first terminal, through the first or second base station,
calculate a carrier sense threshold for each pair of the one or more first terminals and the second base station, based on the received first and second received power values, and
transmit the calculated threshold to the first base station.

2. The control apparatus according to claim 1,
wherein the processor further configured to
calculate the threshold, when the first base station and the second base station are capable of communication at the same time for a second terminal under control of the second base station.

3. The control apparatus according to claim 2,
wherein the processor further configured to
calculate the threshold for a pair of the first terminal and the second base station, as a value larger than a third received power value for a third signal received by the first base station from the second base station, when the first base station and the second base station are capable of communication at the same time for the first terminal.

4. The control apparatus according to claim 2,
wherein the processor further configured to
calculate the threshold for a pair of the first terminal and the second base station, as a value less than a third received power value for a third signal received by the first base station from the second base station, when the first base station and the second base station are not capable of communication at the same time for the first terminal.

5. The control apparatus according to claim 2,
wherein the processor further configured to
calculate the threshold of all the first terminals under control of the first base station for the second base station, as a value less than a third received power value for a third signal received by the first base station from the second base station, when the first base station and the second base station are not capable of communication at the same time for the second terminal.

6. The control apparatus according to claim 5,
wherein the processor further configured to
calculate the threshold for a pair of all the second terminals under control of the second base station and the third base station, as a value less than the third received power value, when a fourth received power value of a third base station adjacent to the first base station for a fourth signal received from the first base station is larger than the third received power value.

7. The control apparatus according to claim 2,
wherein the processor further configured to
calculate the threshold, when a ratio of a fifth received power value for a fifth signal received from the second base station to a sixth received power value for the first signal received from the first base station is equal to or greater than a desired value, in a second terminal under control of the second base station.

8. The control apparatus according to claim 7,
wherein the processor further configured to
calculate the threshold as a value less than a third received power value for a third signal received from the second base station by the first base station, when the ratio is less than the desired value.

9. The control apparatus according to claim 3,
wherein the processor further configured to
calculate the threshold as a value larger than the third received power value, when a ratio of the first received power value to the second received power value is larger than the desired value in the first terminal.

10. The control apparatus according to claim 9,
wherein the processor further configured to
calculate the threshold as a value less than the third received power value, when the ratio is equal to or less than the desired value in the first terminal.

11. The control apparatus according to claim 1,
wherein the processor further configured to
calculate a threshold for each pair of the first terminal under control of the first base station and the second terminal under control of the second base station, based on the received first and second received power values.

12. The control apparatus according to claim 11,
wherein the processor further configured to
calculate the threshold for a pair of the first terminal and the second terminal, as a value larger than a third received power value for a third signal received by the first base station from the second base station, when the first base station and the second base station are capable of communication at the same time for the second terminal, and the first base station and the second base station are capable of communication at the same time for the first terminal.

13. The control apparatus according to claim 12,
wherein the processor further configured to
calculate the threshold for a pair of the first terminal and the second terminal, as a value less than the third received power value, when the first base station and the second base station are capable of communication at the same time for the second terminal, and the first base station and the second base station are not capable of communication at the same time for the first terminal.

14. The control apparatus according to claim 12,
wherein the processor further configured to
calculate the threshold for a pair of all the first terminals under control of the first base station and the second terminal, as a value less than the third received power value, when the first base station and the second base station are not capable of communication at the same time for the second terminal.

15. The control apparatus according to claim 1,
wherein the processor further configured to
calculate the threshold for each pair of the respective first terminals and the second base station when there are a plurality of the first terminals, calculate the threshold for each pair of the first terminal and the respective second base stations when there are a plurality of the second base stations, and calculate the threshold for each pair of the respective first terminals and the respective second base stations when there are a plurality of the first terminals and a plurality of the second base stations.

16. A wireless communication system comprising:
a first base station;
a second base station;
a first terminal configured to be under control of the first base station; and
a control apparatus comprising:
a memory; and
a processor coupled to the memory and configured to:
receive a first received power value for a first signal received from the first base station and a second received power value for a second signal received from the second base station adjacent to the first base station in the first terminal, from the first terminal, through the first or second base station,
calculate a threshold for each pair of the one or more first terminals and the one or more second base stations, based on the received first and second received power values, and
transmit the calculated threshold to the first base station.

17. A control method comprising:
receiving, by a processor, a first received power value for a first signal received from a first base station and a second received power value for a second signal received from a second base station adjacent to the first base station in a first terminal under control of the first base station, from the first terminal, through the first or second base station,
calculating, by a processor, a threshold for each pair of the one or more first terminal and the one or more second base stations, based on the received first and second received power values, and
transmitting, by a processor, the calculated threshold to the first base station.
